(19) United States
(12) Patent Application Publication
(10) Pub. No.: US 2005/0044069 A1
(43) Pub. Date: Feb. 24, 2005

(54) Commercial data registry system

(76) Inventors: Frederick J. Geiger, Washington Crossing, PA (US); Michael Klybor, Annapolis, MD (US); William Lee Rosenfeld, Lexington, MA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/751,055

(22) Filed: Jan. 2, 2004

Related U.S. Application Data
(63) Continuation of application No. 09/753,068, filed on Dec. 29, 2000, now abandoned.

(51) Int. Cl. G06F 7/00

(52) U.S. Cl. 707/3

(57) ABSTRACT

A commercial data registry system provides a database connected to a computer network in order to allow access to an authoritative repository of records relating to goods and services. Trading partners may subscribe to receive updated commercial data pertaining to goods or services in which they presently deal and/or goods or services of potential interest to them. Integration of registry operations with existing electronic commerce procedures provides continuously valid data to facilitate business to business transactions.

### FIELD OF THE INVENTION

The present invention relates to a registry system for maintaining authoritative data on goods and services in commerce. In particular the present invention relates to an interactive registry system for allowing trading partners to maintain synchronized local databases of selected data pertaining to goods and services of interest.

### BACKGROUND OF THE INVENTION

Efficiently matching the capabilities of suppliers with customers is the essence of commerce. Given the large variety of commercial goods and services available from suppliers in the modern economy, and the similarly diverse needs among retailers and other participants in the distribution chain, it can be difficult to locate effective matches among trading partners. It can also be difficult for trading partners to maintain efficient relationships when new products are introduced or when specifications of existing products are changed (and, conversely, when demand specifications are changed). A grocery store chain, for example, must manage thousands of individual trading relationships. A supply partner at the other end of one of those relationships may also be tasked with managing thousands of other relationships with retailers. Each of these relationships may involve keeping track of the locations of a large number of data items provided in a variety of formats. It would thus be desirable to provide a uniform registry system by which suppliers may indicate their supply capabilities and by which demand partners may indicate their interest in particular supply capabilities. It would further be desirable to provide such a registry system which provides flexible access methods suitable to the needs of high and low volume trading partners.

### SUMMARY

In accordance with the present invention, there is provided a commercial data registry system for providing a uniform, secure, and neutral source of supplier capabilities and demand partner preferences among commercial trading partners. The registry comprises a database and a network interface for providing access to the database via several alternate methods. The database stores records of goods and services available from suppliers, locations of trading partners, and subscription records of trading partners indicating goods and services of interest to them. The network interface is configured to provide a graphical user interface to trading partners desiring to access the database manually, and the network interface is further configured to receive and process XML document transmissions for trading partners desiring high volume access. Functions provided by the registry system of the present invention include providing selective notifications to user of events of interest to them via a subscription mechanism; selective publication of new or modified supplier capabilities, goods or services; synchronization of local databases provided to enable offline access to a selected portion of the data within the registry; enforcement of commercial data format standards; and processing and storage facilities for providing message queues to trading partners in response to new or modified registry data items, or responses obtained to published registry data items.

### BRIEF DESCRIPTION OF THE DRAWINGS

The foregoing summary and the following detailed description will be best understood when read in conjunction with the appended drawings, in which:

FIG. 1 is a functional block diagram of a system architecture of a commercial data registry system in accordance with the invention;

FIG. 2 is a flowchart of a method of the present invention;

FIG. 3 is a view of a graphical user interface screen for establishing a trading partner identity for registration in the commercial data registry;

FIG. 4 is a view of a graphical user interface screen for establishing an item record for storage in the commercial data registry;

FIG. 5 is a view of a graphical user interface screen for establishing a subscription record for storage in the commercial data registry;

FIG. 6 is a view of a graphical user interface screen of a notification worklist of items of interest to a trading partner obtained from the registry;

FIG. 7 is a view of a graphical user interface screen of a detailed notification of an item from the worklist of FIG. 6;

FIG. 8 is a view of an email message notification of an item of interest to a trading partner obtained from the registry; and

FIG. 9 is a view of an XML document transmission of a notification of an item of interest to a trading partner obtained from the registry.

### DETAILED DESCRIPTION OF THE INVENTION

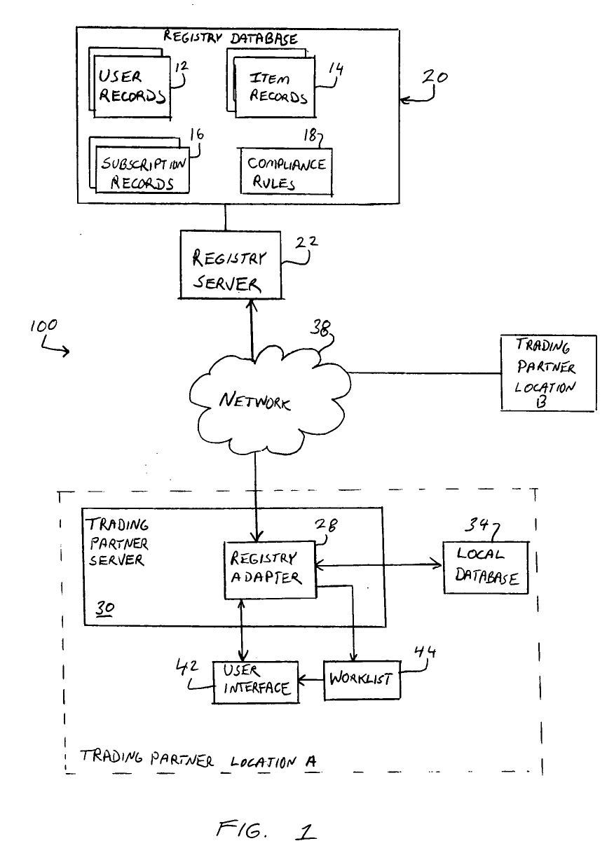

Referring to FIG. 1, a system architecture of the invention is shown. The system architecture provides an environment to support processes that are used to synchronize information among system subscribers, herein referred to as trading partners. Trading partners include supply-side partners, those that produce items, and demand-side partners, those that purchase items. The system 100 includes a registry database 20 which contains information to be exchanged among users belonging to the community of trading partners. The registry database 20 contains user records 12 which contain information regarding the users, item records 14 which describe commercial goods or services, subscription records 16 which define types of information users desire to receive from the registry database 20, and a set of compliance rules 18 which define various requirements of the data content of the registry database 20.

The user records 12 establish partner profiles containing contact information for subscribers to the registry, which include trading partners such as supply-side partners and demand-side partners. In addition, each user record 12 contains information defining that user's role. The role information defines access control permissions for a given user. In order for a user to a perform a given function in the system, a user must have been granted permission for that function when the user record for the corresponding partner profile was defined.

Each of the item records 14 contains a Global Trade Identification Number (GTIN) unique to each product or service, and unique to a single trading partner. Basic item data contained in an item record 14 may include descriptive information, date of availability, dimensions, order increment, and other miscellaneous information. The basic descriptive information includes a product type, product code, unit description, category, and brand to provide a basic description of the item. The product type, product code and category information may be based on a predefined lexicon of terms. For example, the product type and code may be selected from terms of the EAN (European Article Number) or UCC (Uniform Code Council) standards, and the category information may be selected from terms of the IRI standard. Since a particular item may be available on a seasonal or temporary basis, the product item records 14 may include date of availability information. Physical dimensions and weight may also be specified for item records 14 corresponding to goods. A supply-side user may also specify minimum, maximum, or increment order limits as part of the product item records 14. Further information such as special handling codes, colors, and hazardous material data, may be included within an product item record 14.

The subscription records 16 are defined by users desiring notification of specific types of information from the registry database 20 as well as notification and delivery of such information as it is added to the registry database 20. A subscription may include requests for information regarding specific items, trading partner organizations, users, or other information maintained within the registry database. For example, a subscription may contain a user's request to receive selected notifications about particular items. The particular item can be defined, for example, in terms of an IRI category or a specific GTIN item identifier. The subscription may further specify selected notifications be delivered, such as notifications of new items only, deletions only, or all changes respecting the particular item. Alternatively, a subscription may contain a request for information regarding trading partners or categories of trading partner organizations rather than items. Multiple users may be defined within each trading partner organization, so that individuals having separate areas of trading responsibility may define subscriptions pertaining to their area. For example, a retailer may define individual managers responsible for various departments within a retail establishment. Information to be supplied in response to subscription requests may be queued in a messaging queue 36.

The system 100 includes a registry server 22 for controlling the flow of information to and from the registry database 20 and a data communications network 38. Users communicate with the registry database 20 via a trading partner server 30 connected to the data communications network 38.

The trading partner server 30 implements a registry adapter 28 which includes a user interface 42 and a notification queue, or worklist 44. The worklist 44 receives and maintains a list of notifications delivered by the registry database 20 to the registry adapter 28. Such notifications contain data from the registry database 20 which are compiled according to the user's requests present in one or more subscription records 16. The notifications are provided to users who subscribe to receive information when events of interest occur, such as the addition or updating of selected types of information within the registry database 20, in accordance with the subscription records pertaining the trading partner.

A user may access the worklists 44 using the user interface 42. The user interface 42 is further configured to enable the user to enter subscription requests, user information, item information, to be uploaded to the registry database 20.

Trading partners may maintain a local database 34, which may include a pre-existing, or legacy, database system maintained by the trading partner for storing commercial data relevant to the partner. The local database 34 enables offline access to subscribed data. For example, the local database 34 may include the user records, the user's subscriptions and item information relevant to the user's subscriptions. The local database 34 is synchronized to the registry database 20 as described below.

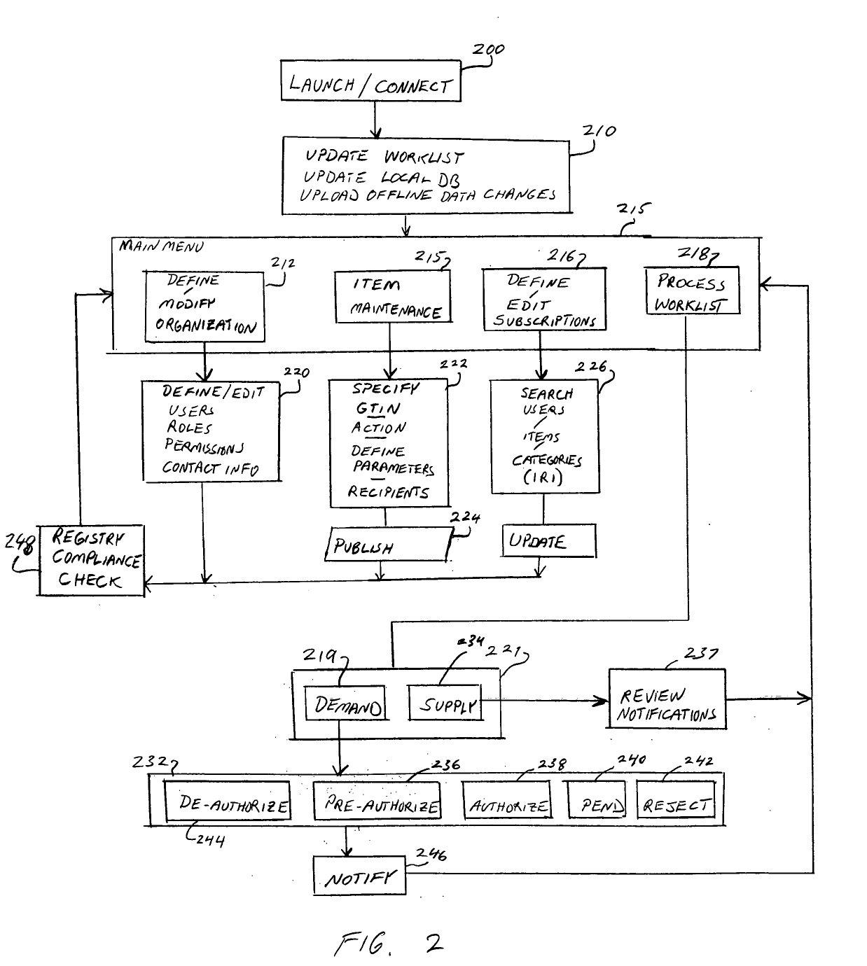

FIG. 2 illustrates functions provided by the registry adapter. To initiate use of the system by a trading partner, a connection is made between the trading partner server and the registry database, at step 200. When a connection is made, the registry transmits notifications pertaining to the user's subscription records, if any. Upon receipt of this information, the trading partner server updates the worklist, at step 210. For a system configuration incorporating a local database, the local database is updated by the registry adapter to reflect the information presently contained in the registry database, at step 210. The registry adapter stores the received registry data in the local database to synchronize the local database with the registry database. Synchronization to update the local database to reflect the registry database contents may be initiated by the registry server as new data are received and/or by the registry adapter polling the registry database. In the former scenario, the registry database maintains a list of all known registry adapters, the date of their last update, and the subscription records pertaining to each registry adapter. As new or altered information is added to the registry database, the registry server sends that information from the registry database to the registry adapter. By this method, updates only occur if there are updates to the registry database, which reduces unnecessary traffic if updates occur infrequently. In the latter scenario, the registry adapter requests synchronization by periodically polling the registry database for updates. Polling may also be conducted at particular times in response to specific needs for data. An advantage of this method is that data is requested on an as needed basis.

Having updated and synchronized the trading partner server to the registry database, the user may proceed to perform one or more of the functions depicted in block 215. The user's ability to perform any of the operating functions depends on the user's role and access permissions. In order for a user to a perform a given function in the system, a user must have been granted access control permission for that function. Depending on a user's role she may have permission to merely view and not alter information, for example.

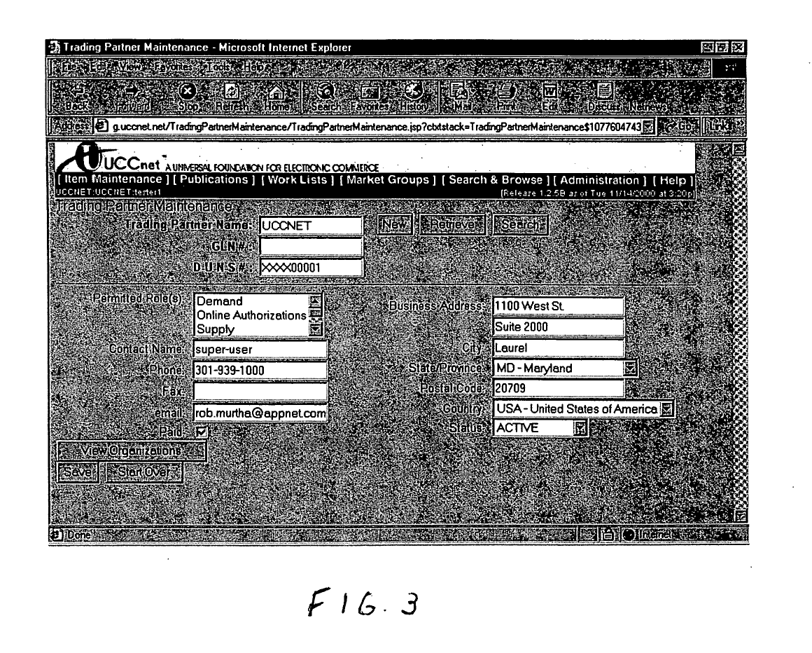

Organizational information can be defined or modified by selection option 212 from block 215. Each trading partner creates and maintains a profile, a list of users and their associated roles to define the trading partner's organization. This function is performed by the trading partner's system administrator. The system administrator defines and modifies an organizational structure of users at step 212, beginning with defining the trading partner's users at step 220. Definition of the user begins with establishing a user ID which is unique among all users of the trading partner community. Such a user ID may be, for example, a DUNS number as shown in the initial partner profile definition screen in FIG. 3. The user ID is associated with the organization as part of the user ID record. The user ID record also includes contact information for the user and the role of the user.

A role is a logical grouping of one or more permissions. Roles typically correspond to job functions. The system includes certain predefined roles, such as trading partner administrator, user administrator, category manager, or general user. A general user role grants access control permission to search/browse all items and to view information such as categories, other trading partner descriptions, authorizations for products available to their organization, publication requests targeted to their organization, and data subscriptions for their organization. Further roles may grant access control permissions that depend on whether the role is assigned to a supply-side user or a demand-side user. For example, a supply-side trading partner administrator role grants permission to perform the function of item maintenance, step 214, described below. The category manager role corresponds to a job function that is specific to a demand-side user. The category manager role grants permission to authorize, de-authorize, pre-authorize, reject, or pend an item, as described in association with steps 236-246 below.

The system administrator for a trading partner may also define the method of access to the registry which will be employed by that trading partner, or by users within the trading partner organization. The registry system is configured to allow different methods of access in accordance with user preferences. For example, the registry may provide GUI access to the system functions described below and provided by the registry server via a “thin” client, such as a browser; the registry may provide for processing of messages to be delivered via email; or the registry may communicate with the trading partner server via XML messages. GUI access may be preferred by relatively low volume subscribers desiring to manually perform the various functions described herein, while XML messaging may be preferred by high-volume subscribers who desire to configure their servers to automatically format and process the functions described herein and/or to communicate with their pre-existing internal data management systems. Hence, it will be appreciated that the functions described herein are capable of being performed manually by a graphical interface to the registry system, automatically by an XML messaging system, or on a hybrid basis in which the trading partner provides its own custom user interface to an XML message processing system.

A second option provided at block 215 is item maintenance. Item maintenance is performed by a supply-side trading partner administrator, at step 214. Item maintenance includes adding new items or editing, withdrawing, or removing existing items. After specifying the appropriate data at step 222, the new or modified item record is published in step 224 by transmitting the new or modified record from the trading partner server to the registry server.

The process of adding a new item entails creation and entry of a GTIN item identifier unique to that item and the entry of additional attributes defining the item. Examples of attributes include category information, brand, unit descriptors, data availability, dimensions, order increments, and other attributes as described above. The process of editing existing item information encompasses changing any of these attributes, with the exception of the GTIN identifier. These changes, however, are subject to restrictions imposed by the rules. Once a item has been entered into the registry database, the rules prohibit altering selected attributes that define the item. For example, if the item is a black pen, changing its color attribute to “red” would not be permitted by the rules. Under this scenario, the color of a pen is deemed to be a defining attribute of the item. Denying such a change prevents a demand-side user who has come to associate a particular GTIN item identifier with a black pen from receiving a red pen by mistake.

The supply-side trading partner administrator may also edit an existing item as part of item maintenance to indicate that the existing item is being replaced by a new item. In this case, the supply-side trading partner administrator enters a “replaced by” attribute in the existing item that points to the new item. A sample graphical interface user screen for publication maintenance is shown in FIG. 4. As can be seen therein, a supply-side trading partner may specify whether a publication indicates a new item, a data change to an existing item, a withdrawal of a publication, or a de-listing of an item. Provisions are also made for linking items to indicate that a item is contained within another item.

All the information entered by the supply-side trading partner administrator, for both new items and changes to existing items, are verified in a compliance checking step, step 248. Compliance checking uses accepted standards, such as those defined in the rules of the registry database, to validate the item information. For XML transmissions, the received XML documents are compared with a predetermined document type definition established at the registry. The basic checks performed on an attribute-by-attribute basis include ensuring that the numerical fields are numeric, that lengths are not exceeded, that value lists are enforced (e.g., that the unit of measurement attribute contains one of the valid codes), and that the minimum/maximum values are numeric fields. Beyond the basic checks, there are more advanced checks that rely on the business logic and specific fields. For example, there are numerous detailed validations that occur on the GTIN item identifier such as verifying a checksum digit and ensuring that the prefix of the GTIN item identifier is valid for the user publishing the item.

Date attributes are subjected to a variety of validations such as confirming that the “first ship dates” are not earlier than the “first order dates.” Some validations depend on the data entered. For example if an “order increments” is entered then a “unit of measure” must be supplied for it.

The graphical user interface is preferably designed to provide feedback on each attribute as it is entered. In the case of an XML messaging subscriber, messages received by the registry are checked upon receipt. The system is designed to allow most items to be stored in the registry database, but not published to the community if they fail validation. A more rigorous set of validations are performed when the item is published. This approach facilitates a supply-side user's workflow, since a item can be set up with available information and supplemented as additional information becomes available before the item is published to the larger community. Another level of compliance checking is provided through audit trails that are built into the system. These provide “non-repudiation” so trading partners can confirm the details and timing of offers. To facilitate development of partner systems that are compliant with the requirements, a local compliance checking option is provided as part of step 248. Local compliance checking allows users to run validations on their own application without a connection to the registry database.

As part of the publication step 224, the supply-side trading partner administrator may specify which demand-side trading partners may receive notification of the associated item. Such selective notification permits the supply-side trading partner to specify the markets it wishes to serve. For example, the supply-side trading partner may wish to limit the market to a geographic region, only retailers, only wholesalers, or to trading partners whose profile information indicates that they are involved in a specified market group. Conversely, a supply-side trading partner administrator may “withdraw” item and from a particular demand-side trading partner, so that the demand-side trading partner no longer receives notifications respecting that product. Additionally, delivery of notices by publication is further limited to those demand-side trading partners who have subscribed to the type of information contained within a particular publication. This prevents demand-side trading partners from receiving notifications about products in which they have no interest.

The next option provided in option block 215 is defining subscriptions. A demand-side or supply-side user may enter a subscription request, at step 216. A subscription request indicates that the user is interested in receiving a notification about selected items or other system information. Primarily subscriptions are used to receive information about items. However, a user may enter subscription to be informed when a new trading partner enters the system, especially a trading partner who supplies or purchases products of interest to the subscribing user. The process for creating a trading partner subscription is analogous to the process for creating an item subscription.

Creation of a subscription begins with the user searching the item records of the registry database or local database for particular item of interest, at step 226. After identifying the item in which the demand-side user is interested, the demand-side user publishes a subscription request to the registry database. The publication includes the steps of updating and compliance checking the subscription request prior to its posting to the registry database, at steps 228 and 248. Subscription requests may be created via access to a graphical user interface utility, or by direct XML messages sent to the registry.

The process for creating a trading partner subscription request utilizes the same steps, with the search step performed on a trading partner records contained within the user records of the registry database. Similarly a supply-side user may create a subscription to request notification when a demand-side user creates an item subscription respecting to item the supply-side user offers. Users may further create subscriptions to be notified of changes in organizations, user information, categories and trading partners as well as to be notified when authorizations, publication requests, or batch jobs occur.

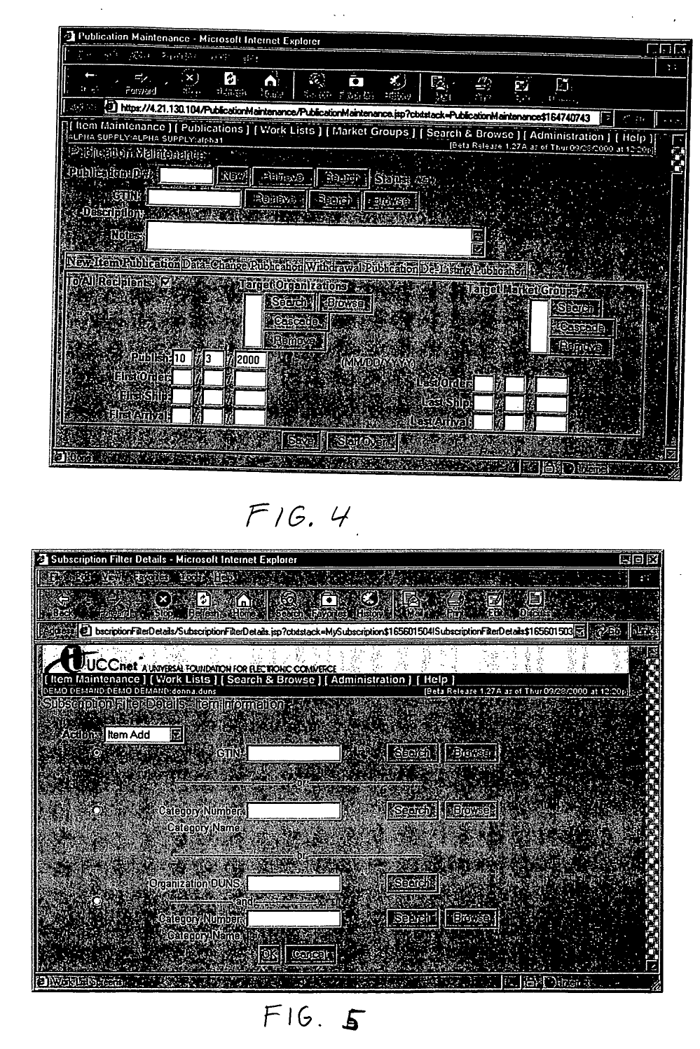

Notifications delivered in response to subscription requests are managed by users via work lists. A user processes a work list, at step 218, to manage his outstanding tasks. The work lists may be modeled after e-mail in baskets and provide a mechanism that allows users to prioritize their work as well as to follow upon outstanding issues. Notifications can be received via the system's graphical user interface, through e-mail, or through a batch XML message. The graphical user interface provides the user with selections based on message type and provides the ability to scroll through the work list of outstanding messages defined as those of interest, as shown in FIG. 5.

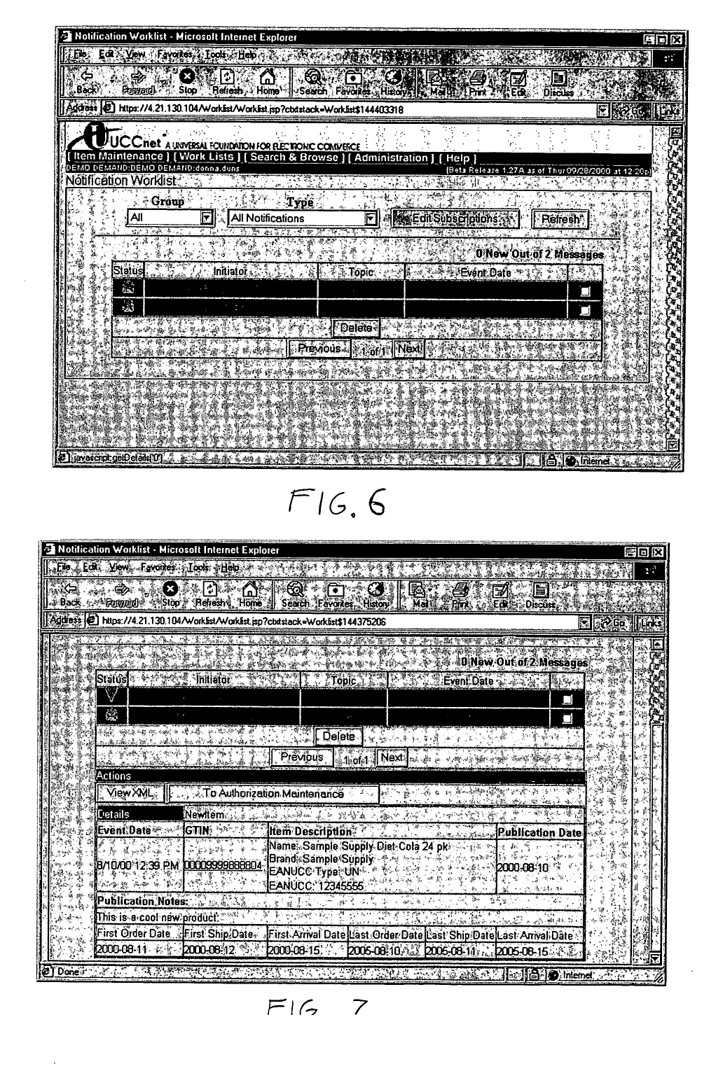

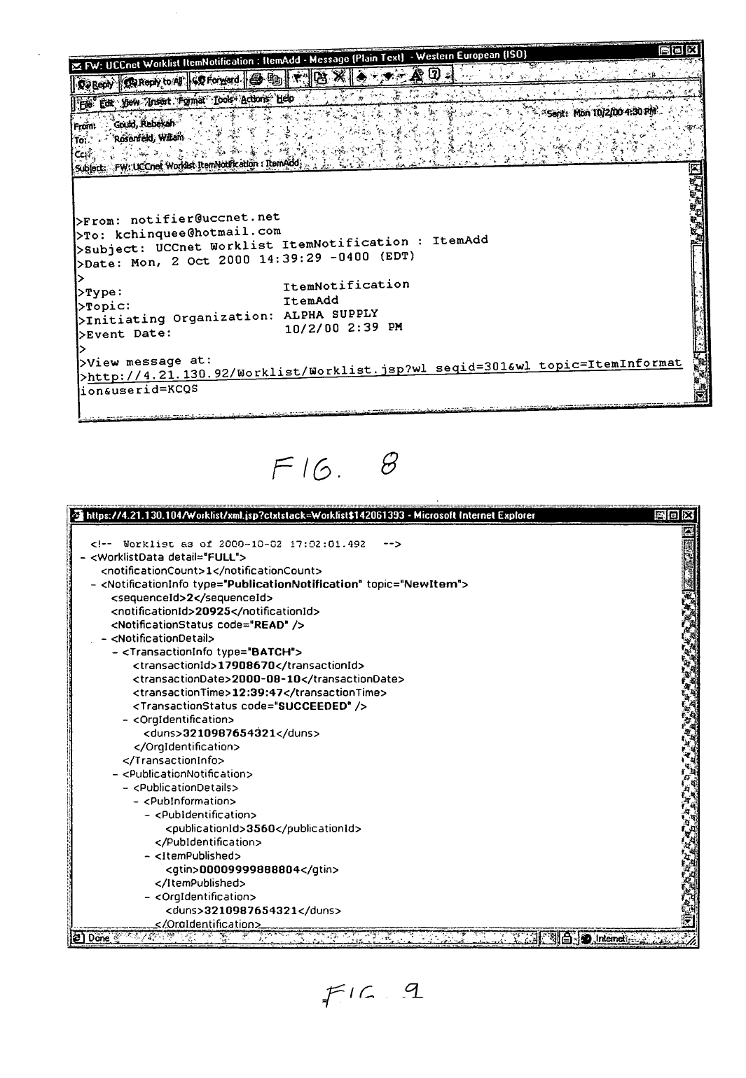

Based on the summary information displayed by the graphical user interface, the user can drill down to view the details contained within the notification, as shown in FIG. 6. This provides additional details about the item being updated, for example for a item notification, such as effective dates, and provides links for further item detail and for authorization actions. As noted above, users who do not plan to regularly use the graphical user interface may elect to receive notifications via email. Notification email messages contain an active link to appropriate screens by which the user may perform the authorization maintenance steps described below. A sample email notification message is shown in FIG. 7. For trading partners utilizing XML notification, the registry delivers an XML formatted message, as shown in FIG. 8, including a set of data fields defining the notification. Notification via such XML messages allows such subscribers to develop or obtain a custom interface designed to integrate the receipt of XML messages with their pre-existing data management systems and to automate processing of incoming messages.

The authorization maintenance steps for processing a item notification in a work list of a demand-side user (proceeding from option block 219 of step 221) is depicted as option menu 232 of FIG. 2. Authorization maintenance is the process of changing the authorization status of a item. Authorization of the product by a demand-side user establishes the beginning of the buying process for the item. The first authorization maintenance event occurs for a product after the demand-side user is notified of the item. Specifically, a category manager receives notification of a new item and makes a decision to pre-authorize, authorize, pend, de-authorize, or reject the item, as shown at steps 236, 238, 240, 244, or 242, respectively. To pend means to hold for later processing, to reject means that there is no interest in the item, and to authorize means that there is interest to purchase in the item. Pre-authorization indicates that the demand user intends to accept the item and will initiate the process of synchronizing all the in-house related systems to accept the item (e.g., accounts payable, merchandise management system, and the warehouse management system). Once these updates are complete, the item is authorized and the supply-side trading partner can be confident that the demand-side user has accepted the item and synchronized all of his systems. De-authorize indicates that the demand-side user no longer is interested in buying the product.

After the user has processed each item in the worklist or, alternatively, after all items have been processed, the user interface proceeds to step 246 in which notification of the user action is transmitted back to the registry for placement in an appropriate message queue for the corresponding supply-side partner(s). These notifications are subsequently delivered to the appropriate supply-side partner(s) and added to their worklist(s). Proceeding from option block 234 of step 221, a supply-side partner may review such notifications in step 237 in order to take appropriate action in response thereto. While not constituting a contract execution mechanism, the notifications received by the supply-side partner(s) provide expressions of interest or disinterest by which the supply-side partner may take appropriate action for commercial engagements.

The terms and expressions used herein are intended as terms of description, and not of limitation, and there is no intent by the use of such terms to exclude equivalents thereof from the scope of the invention as defined by reference to the appended claims.

1. A method of collecting and distributing commercial data among suppliers and purchasers, comprising the steps of:
establishing a registry database for containing:
user records defining contact information pertaining to respective suppliers and purchasers,
item records defining goods or services offered by the suppliers,
subscription records defining goods or services of interest to purchasers
connecting the registry database with a data communication network;
connecting a local processing adapter to the data communication network at a user location, the local processing adapter performing steps of:
enabling a user to establish a user record, and
enabling a user to establish a subscription record,
receiving item records from users at the registry;
matching received item records with subscription records;
transmitting notifications of item records from the registry to the local processing adapter on the basis of said matching step.

2. The method of claim 1, further comprising the steps of receiving said notifications at the local processing adapter, arranging said notifications into a list of notifications, accepting user options in response to said notifications provided on said list.

3. The method of claim 1, further comprising the step of storing a set of compliance rules in the registry data, and comparing each of said notifications with said compliance rules prior to entry in the registry.

4. The method of claim 1, further comprising the step of providing a local database at the user location for storing at least a selected portion of the registry item records, and further comprising the step of directly updating the local database in accordance with said notifications, to maintain synchronization of the local database with the registry database.

5. The method of claim 4, further comprising the step of providing said notifications to a user interface in parallel with updating the local database.

6. The method of claim 1 wherein the step of receiving item records comprises receiving item records in extensible mark-up language (XML) format.

7. The method of claim 6, further comprising the step of checking receiving item records for compliance with a predetermined document type definition.

8. The method of claim 1 wherein the step of transmitting notifications comprises the step of transmitting said notifications in the form of at least one of: (i) a worklist delivered to the local processing adapter via a graphical user interface to the registry, (ii) an email message, and (iii) an XML document transmission, on a user-selectable basis.

9. A registry for providing commercial trading partners with access to information pertaining to goods or services, comprising:
a database configured for storing records defining goods and services offered by trading partners;
a network server for connecting the database with a computer network and configured to provide a graphical user interface accessible to the trading partners through said computer network via a thin client, for enabling trading partners to establish said records and to search said records, the network server further configured to receive document transmissions establishing said records, whereby the trading partners may selectively employ one of said graphical user interface and said document transmissions to establish said records.

10. The registry of claim 9 wherein said network server is configured to receive said document transmissions in XML format.

11. The registry of claim 9 wherein said database is further configured to store records defining categories of goods and services of interest to each of said trading partners, and wherein said network server is configured to transmit notifications to said trading partners upon establishment of a new record within a defined category of interest.

12. The registry of claim 11 wherein said network server is configured to transmit said notifications in the form of: (i) a worklist accessible through the computer network via a graphical user interface to the network server, (ii) an email message, and (iii) an XML document transmission, on a user-selectable basis.

13. The registry of claim 12 wherein the notifications comprise XML document transmissions, and wherein the network server is configured to determine compliance of said transmissions with a predetermined document type definition.

14. The registry of claim 11 wherein said network server is configured to receive responses from the trading partners to said notifications, and to deliver said responses to the trading partner corresponding to said new record.

15. The registry of claim 14 wherein said network server is configure to receive said responses in the form of predetermined messages indicating interest or lack of interest in the good or service defined by the new record by a responding trading partner.

16. The registry of claim 11 wherein the network server is configured to communicate said notifications to at least one local database maintained by a trading partner, to maintain synchronization of the local database with the registry database.
